(19) United States
(12) Patent Application Publication
(10) Pub. No.: US 2008/0206500 A1
(43) Pub. Date: Aug. 28, 2008

(54) Oxygen Scavenging Film

(76) Inventors: Pieter Gijsman, Beek (NL); Alexander Antonius Marie Stroeks, Valkenburg aan de Geul (NL)

Correspondence Address: NIXON & VANDERHYE, PC, 901 NORTH GLEBE ROAD, 11TH FLOOR, ARLINGTON, VA, 22203, US

(21) Appl. No.: 11/917,196

(22) PCT Filed: Jun. 8, 2006
(86) PCT No.: PCT/EP2006/005481

§ 371 Date: Apr. 2, 2008

(30) Foreign Application Priority Data
Jun. 15, 2005 (EP) 05076390.3

(51) Int. Cl. B32B 27/18; B32B 27/08; B32B 27/34; B32B 27/36; A23L 3/3436; B65D 81/26

(52) U.S. Cl. 428/35.7; 526/89; 428/500; 428/480; 428/474.4

(57) ABSTRACT

Oxygen scavenging multilayer film, comprising a layer that comprises an oxygen scavenging composition, said layer being separated from a first surface of the film by one or more first layers, characterized in that the oxygen scavenging composition comprises a copolymer comprising substituted polypropylene oxide segments and polymer segments and an oxidation catalyst, wherein the copolymer has been prepared by copolymerising the corresponding monomers of the polymer segments in the presence of functionalised substituted polypropylene oxide segments, wherein the first layers have an overall oxygen permeability of at most 500 cm³/m²·24 h·atm.

The invention relates to an oxygen scavenging (OS) multilayer film, comprising a layer that comprises an oxygen scavenging composition, said layer being separated from a first surface of the film by one or more first layers and having an inner and an outer surface.

Such film is known from WO99/15433 as a.o. a three-layer film in which the oxygen scavenging layer is sandwiched between two other layers. In this film as the oxygen scavenging composition a composition is applied that has been prepared by reactive extrusion of polymer segments, in particular of a polycondensate, and a functionalised oxygen scavenging moiety. The resulting product, denoted as copolycondensate, is applied as such or diluted (=blended) with a further polymer as a single layer or as a layer in multi layer films. It has appeared that this composition has a restricted efficiency in oxygen scavenging properties, making it necessary to apply thicker layers to obtain a certain degree of active oxygen barrier properties or to provide the layer with sufficient oxygen absorption capacity.

Aim of the invention is a multilayer film as defined above that shows better active oxygen barrier properties than the known composition and better oxygen absorption properties.

This aim is achieved according to the invention in that the oxygen scavenging composition comprises a copolymer comprising substituted polypropylene oxide segments and polymer segments and an oxidation catalyst, wherein the copolymer has been prepared by copolymerising the corresponding monomers of the polymer segments in the presence of functionalized substituted polypropylene oxide segments, and in that the first layers have an overall oxygen permeability of at most 500 cm³/m²·24 h·atm.

Surprisingly the fact that the polymer segments have been formed from copolymerisation of the corresponding monomers with functionalised substituted polypropylene oxide segments rather than having these polypropylene oxide segments react with already polymerised polymer segments appears to cause a considerable favourable difference in oxygen scavenging properties of the composition.

From WO01/10947 it is known to apply substituted and unsubstituted poly(alkylene)glycol segments as oxygen scavenging moieties with alkylene chains of 4 or more carbon atoms but as chains of 1 to 3 carbon atoms only unsubstituted alkylene chains are used. Moreover in Example 36 (comparative) it is concluded that poly(propylene)glycol, a substituted polypropylene oxide, is inferior to poly(tetramethylene)glycol and thus it is not preferred. This makes it even more unexpected that the OS composition comprising substituted polypropylene oxide gives good OS properties to multilayer films.

Preferably the monomers that have been polymerised to form the polymer segments in the copolymers in the presence of the substituted PPO segments, are those that form condensation polymers as polyesters and polyamides. Examples of polycondensate segments that can be applied with favourable results in the composition according to the invention are polyester and polyamide segments. Examples of suitable polyesters are polyethylene terephthalate (PET), polybutylene terephthalate (PBT), polyethylene naphtanoate (PEN), polybutylene naphtanoate (PBN). Examples of suitable polyamides (PA) are aliphatic polyamides, that may eventually be branched polyamides, such as PA6, PA4,6, PA6,6, PA 11, PA12, semi aromatic polyamides as MXD6, PA6,I/6,T, PA6,6/6,T, fully aromatic polyamides and copolymers and blends of the listed polyamides and polyesters. The effect of the invention is particularly effective in compositions comprising aliphatic polyamide as the polycondensate since these polyamides as such have lower oxygen barrier properties than e.g. aromatic polyamides.

The copolymer has been prepared by copolymerising the corresponding monomers of the polymer segments in the presence of substituted polypropylene oxide (PPO) segments. To allow the monomers to attach on the PPO segments these segments are functionalized with end groups that can react with reactive sites of the monomer. Examples of such functional end groups and reactive monomer sites are e.g. —OH, —NH₂, acid, epoxy and other functional groups known in the art as reactive with polyamide monomers.

Suitable PPO segments are linear oligomers of PPO and are of the substituted type. In IUPAC nomenclature this PPO is denoted as polyoxy-1,2-propanediyl. They consist of 2 to 5000 polypropylene oxide monomer units, preferably of 10 to 2500 units and in this shape and size they have been copolymerised with the monomers. In this range an even distribution of the copolymers in the polycondensate appears to be achieved. During this copolymerisation copolymers of the -ABABA- type are formed comprising polymer segments A of variable length alternated with propylene oxide segments B.

In another embodiment the substituted PPO segments are present as branches in a two, three, four or higher star branched compound the centre unit of which can be e.g. a di-, tri-, tetra or higher functional ester, amide, ether, urethane. In the process of preparation of the copolymer applied in the composition of the invention, the polymer segments then grow from the free ends of the PPO segment branches. During this copolymerisation linear copolymers can be formed of the type ABA or branched copolymers having branches of the type BA.

Apart from the PPO segments also other ether segments optionally may be present as e.g. polyethylene oxide, however in smaller amounts than the PPO. Preferably the other ether segments are present in amounts less than 40 wt %, more preferably less than 30 wt % or less than 10 wt % of the amount of PPO. An example of this is a block poly(ethylene)oxide-substituted PPO block-block poly(ethylene)oxide triblock segment.

These copolymers can be formed by reacting the functionalised substituted PPO in the presence of the monomers at conditions well known for the polymerisation of the corresponding monomers or according to U.S. Pat. No. 4,590,243 and EP 0067695.

In these processes, apart from the monomers and the PPO segments, also other compounds can be present, for example catalysts, chain stoppers, stabilisers and the like. Linear PPO segments are introduced in these reactions as divalent moieties that are functionally terminated at their ends, e.g. with hydroxy, amino or acid or other groups that are capable reacting with the monomers the polymer part is polymerised from. In star branched type PPO segments the free ends, i.e. those ends of the PPO part of the PPO segment that are not bound to the centre moiety of the star, are functionalised with the groups mentioned above.

The polymer segments in the copolymer may be polyester or polyamide segments but preferably are polyamide segments. This makes the layer suitable as the polyamide layer, which is favourable since a polyamide layer is present in the majority of multilayer films as described above. The layer comprising the oxygen scavenging composition further may comprise polyester or polyamide but preferably comprises polyamide. The layer then comprises a blend of the OS composition and polyester or polyamide. This polyester or polyamide dilutes the oxygen scavenging composition, which allows obtaining, with only a limited number of compositions with a high content of PPO, layers having a wide range of different PPO contents by blending the composition with different amounts of polyester or polyamide.

Polyamides already form a certain barrier for oxygen and are for this and other reasons applied as layers in films, wraps, bottles, vessels or other containers for feed and foods and drinks. They protect the packed goods from direct contact with the environment, including the oxygen in ambient air. Blending polyamide with the OS composition according to the invention considerably enhances its active oxygen barrier properties. It will be understood that a certain desired relative amount of PPO in the composition according to the invention can be achieved by several combinations of the amount of PPO in the copolymer and the amount of polyamide blended into the composition.

The oxygen scavenging composition further comprises an oxidation catalyst, promoting the oxygen scavenging activity of the PPO segments.

Suitable oxidation catalysts include transition metal catalysts, which can readily switch between at least two oxidation states. Preferably, the transition metal is in the form of a transition metal salt or transition metal complex, wherein the metal is selected from the groups 4, 5, 6, 7, 8, 9, 10, 11 and 12 of the periodic system of the elements. Suitable metals include Manganese II or III, Iron II or III, Chromium II or III, Cobalt II or III, Copper I or II, Nickel II or III, Rhodium II, or II or IV and Ruthenium I, II or IV, Titanium III or IV, Vanadium II, IV or V.

Preferably Co II or III is used as the metal part in the catalyst.

Suitable counter ions for the metal include, but are not limited to, chloride, acetate, acetylacetonate, stearate, propionate, palmitate, 2-ethylhexanoate, neodecanoate or naphtenate. The metal may also be an ionomer, in which case a polymeric counter ion is employed. Such ionomers are well known in the art. As an example of a suitable complexing moiety phthalocyanine is mentioned. The transition metal compounds may be present between 10 ppm and 10 wt % in the oxygen scavenging composition. Preferably the amount of transition metal compound in the composition is between 50 and 5000 wt·ppm.

Multilayer films are known per se and usually consist of a number, e.g from 2 to 7 or more, layers, each imparting a certain functionality to the multilayer film. Subsequent layers may be connected directly or through a tie layer. Processes for manufacturing multilayer films are also known per se and the multilayer films according to the invention can be manufactured by these known processes.

The layer comprising the oxygen scavenging composition is at least at one side of the film not an outmost layer forming one of the surfaces of the film. The layer comprising the oxygen scavenging composition is separated from a first surface of the film by one or more first layers that have an overall oxygen permeability of at most 500 cm³/m²·24 h·atm, the oxygen permeability being measured according to ASTM standard 3985 under dry conditions on a film. Preferably the oxygen permeability is at most 250 cm³/m²·24 h·atm and more preferably is at most 125 cm³/m²·24 h·atm.

As these first layer(s), layers can be applied that are known in the art to have passive oxygen barrier properties. Examples of first layers that have passive oxygen barrier properties are layers comprising an oxygen barrier polymer selected from optionally branched polyamide homopolymer, optionally branched polyamide copolymer or blends thereof; ethylene vinyl alcohol copolymer; polyacrylonitrile; polyvinyl chloride (PVC); poly (vinylidene dichloride); and polyesters. Examples of polyesters are polyethyleneterephthalate (PET), polybutylene terephthalate (PBT), polyethylene naphtanoate (PEN) and polybutylene naphtanoate (PBN). More preferably, the first layer(s) comprises polyamide-6 and even more preferably the first layer(s) being polyamide-6. The presence of the first layers having high passive oxygen barrier properties, in a package wherein these layers face the environment, considerably reduces and slows down the penetration of oxygen to reach the layer comprising the oxygen scavenging composition. This enhances and prolongs the lifetime of the composition and thus the oxygen scavenging and barrier properties of the multilayer film.

Further the OS layer may comprise other usual additives that may give a certain additionally required property to the composition, examples of which are fibres, fillers, nano-particles, antioxidants, flame retardants, mould release agents and other compounds known in the art for this purpose. Next to or instead of being present in the OS layer these and other known additives may be present in other layers of the multilayer film.

The oxygen scavenging composition comprising the copolymer and an oxidation catalyst can be prepared by mixing the copolymer with the oxidation catalyst in a separate step or in a step in the process of manufacturing the OS layer or the multilayer film according to the invention.

This mixing can be conducted in the equipment known in the art for mixing thermoplastic polymers such as extruders and mixers. The process applies melt-mixing, i.e. the mixing takes place above the melting point of the oxygen scavenging copolymer but below its decomposition temperature.

The multilayer film according to the invention can advantageously be applied in a headspace oxygen-scavenging package.

Headspace oxygen is the oxygen that is present within a closed package. It may be there as a remainder of the environment in which the material was packed but it may also be generated or released by the contents of the package. The presence of such oxygen is in particular detrimental for foods or other substances that degrade in quality under the influence of oxygen.

In headspace oxygen-scavenging applications the oxygen scavenging composition must be in a sufficiently open contact with the contents of the package so as to allow easy access of the headspace oxygen to the scavenging composition. Providing this easy contact brings about at the same time an easy contact of components present or formed by or in the direct environment of the scavenging polymer with the headspace and the contents of the package. This imposes restrictions to the polymers that can be applied in food packaging applications.

A package as mentioned above is known from WO 03/053171. The oxygen-scavenging polymer is a specific aromatic polymer. This polymer or its monomers are not readily available materials.

In the same document as alternative polymer MXD6 polyamide is mentioned, but it is said to have the disadvantage that the oxygen scavenging reaction generates by-products, which in food packaging application are unwanted since these by-products may not become in contact with the food.

Another category of oxygen scavenging polymers mentioned in said document are unsaturated addition polymers as polybutadiene, said to have the disadvantage that their odor and taste is unpleasant, which makes them also unsuitable for food packaging. As a third category polyolefin based polymers are mentioned, having as a drawback their incompatibility with frequently used materials in packaging applications as polyamide and polyester.

The composition as defined above has the advantage that it is not known to cause any safety problems in food contacts.

Headspace OS applications in fact require an asymmetric multilayer film, in which one surface forms an oxygen barrier to environmental oxygen, whereas the other surface must be sufficiently permeable or even directly accessible to the headspace oxygen.

In multilayer films suitable for headspace oxygen scavenging applications the OS composition is preferably present in a layer forming a second surface of the multilayer film or close to that second surface, then only being separated from said second surface by one or more second layers, the second layers having an overall oxygen permeability of more than 500 cm³/m²·24 h·atm. Preferably the oxygen permeability is more than 1000 cm³/m²·24 h·atm and more preferably is more than 2000 cm³/m²·24 h·atm. The oxygen permeability being measured according to ASTM standard 3985 under dry conditions on a film. Examples of second layers are layers comprising a polymer selected from polyolefin homo- or copolymer, or ethylene vinyl alcohol copolymer. The polyolefin homopolymer or copolymer preferably have a melt flow index of between 0.5 and 15, more preferably between 0.5 and 10. The polyolefin homopolymer or copolymer may be a metallocene catalysed polyolefin homopolymer or copolymer. Non-limiting examples of polyolefin homo- and copolymers are low density polyethylene and linear low density polyethylene.

This second surface then is intended to face, or even be in contact with, the contents of the package

The required minimal oxygen permeability of the second layers, present between the second, inner surface and the layer containing the oxygen scavenging composition, will depend on the amount of oxygen present within the package, the inner surface area that is accessible for this oxygen, the time within which the oxygen has to be removed and the activity of the oxygen scavenging layer. This last parameter can be influenced by the amount of oxygen scavenging compound in that layer, the activity of the compound, also depending on the amount and activity of the catalyst compound used. A skilled person will know to use this guidance to obtain the desired head space oxygen scavenging performance of the package.

The presence of only such second layers as specified above allows the oxygen scavenging composition in the oxygen-scavenging package of the invention to be in an unimpeded oxygen contact with the inside of the package. This means that the headspace oxygen is not hindered to come into contact with the OS composition or only to an extent that still allows the oxygen to reach the composition at a rate that is sufficiently high to remove the oxygen from inside the package in a prescribed time.

In copolymers that can be applied in the oxygen scavenging composition specifically suitable for headspace oxygen-scavenging applications the relative amount of the PPO can be within the range of 0.5 to 85 wt %, preferably of 1 to 70 wt %. Lower amounts will diminish in particular the period during which the oxygen scavenging properties will remain at a high level. Amounts in the higher range, e.g. from 40 wt % upwards, may lead to the formation of a co-continuous phase of PPO segments in the composition. In that case the oxygen scavenging composition and the polymer, if present in the oxygen-scavenging layer, may form co-continuous phases, also when polyamide is present in the oxygen-scavenging layer. This is advantageous for the accessibility of the oxygen-scavenging component by the headspace oxygen and thus enhances the speed by which the oxygen will be removed from inside the package, which is the critical factor in this application.

The package can have any shape that is suitable to pack materials, in particular foods and beverages. Examples of such shapes are films, wraps, bottles, vessels or other containers. The oxygen scavenging composition is present in at least part of the package, e.g. at the inside of the lid or cover of a container or of the cap or crown cork of a bottle, but may also be present in the whole package. It is preferably present in or as one or more layers of a proper thickness. In caps and crown corks due to their small contact are with the headspace, this thickness will be larger than in film packages, where a much larger area can be in direct contact with the headspace. A relevant parameter in this respect is the volume of oxygen scavenging composition present.

Processes for making packages from films and for making bottles etc. are known per se and the commonly used shaping and manufacturing techniques for polymer materials can be used for producing the packages and bottles.

In another embodiment of the multilayer film according to the invention the layer comprising the oxygen scavenging composition is separated from a second surface of the film, opposite to the first surface, by one or more second layers, the second layers having an overall oxygen permeability of at most 500 cm³/m²·24 h·atm. The oxygen permeability being measured according to ASTM standard 3985 under dry conditions on a film.

Such film comprises at both surfaces layer(s) forming a passive oxygen barrier and is suitable for packaging purposes where it is only relevant to keep environmental oxygen away from the goods packaged. The film can be used then with any of both surfaces facing the environment since oxygen barrier layers are present at both sides.

In this embodiment, the relative amount of the PPO with respect to the total of copolymer, if applicable including compounds resting from its polymerisation process, and blended polyamide, if any, may lie within the range of 0.5 to 40 wt %, preferably of 1 to 30 wt % as specified above. Lower amounts will diminish in particular the period during which the oxygen scavenging properties will remain at a high level. Higher amounts may lead to the formation of a co-continuous phase of PPO segments in the composition. This is detrimental for the total oxygen barrier capacity of the composition and thus of the OS layer and therefore the amount of PPO in the composition should be taken so that the PPO forms a disperse phase in the composition.

Packages comprising the described multilayer film show remarkable good oxygen barrier properties and also form part of this invention.

In this last mentioned embodiment type pure barrier applications the oxygen scavenging PPO segments are advantageously present in the composition as small conglomerates. These conglomerates may be spherical and having a size, i.e. a diameter or a smallest axis, an axis being defined as a line connecting two diametrically located points on the surface of the conglomerate, of up to 500 nm and preferably at most 30 or more preferably at most 25% of the conglomerates have a diameter or smallest axis above 500 nm. Spherical is to be understood as having the same or nearly the same dimension in the three spatial directions, deviating from a spherical shape to such extent only that the length of an axis, is at most 1.3 times the length of the diameter of a sphere having the same volume. Preferably at least 50% of the conglomerates have a size of at most 300 nm and preferably of at most 200 nm. More preferably at least 70, 90 or even 99% of the conglomerates is within the specified ranges. A lower conglomerate size has appeared to lead to better oxygen barrier properties.

It was further found that a film according to the invention, comprising a layer of the oxygen scavenging composition, shows enhanced oxygen scavenging performance when a majority of the conglomerates in their shapes have an aspect ratio and in majority are oriented. Such conglomerates can have an elongated or flattened shape, like a cigar or pancake shape. A conglomerate having an aspect ratio is characterized by the feature that its dimension in at least one spatial direction is larger than its dimension in at least one other spatial direction. The ratio between said dimensions preferably is at least 1.3 and more preferably at least 2 or even 5 or even 50 or more than 100. This is contrast to conglomerates that have essentially the same dimension in the three spatial directions. Oriented here means that the largest dimension extends in a spatial direction parallel to a surface of the film that is exposed to oxygen to be scavenged. This largest dimension of the conglomerate in said parallel direction may be larger than 500 nm, even up to some millimetres. However, the dimension of the conglomerate perpendicular to said surface preferably is below 400 nm and more preferably below 350 nm. This appears to enhance the transparency of the oxygen-scavenging layer in the object significantly. An OS layer or multilayer film containing conglomerates having an aspect ratio can be obtained by subjecting the layer or film during or after it being manufactured to an orientating step, e.g. by exposing it to shear in a molten state, by pressing and in particular by drawing in one or more directions.

The invention thus also relates to a multilayer film, having at least one surface that is to be exposed to an oxygen containing environment, and comprising a layer containing the oxygen scavenging composition in which conglomerates of the PPO segments are present, of which conglomerates at least 50%, preferably at least 70% and more preferably at least 90% have a dimension in at least one spatial direction that is larger than a dimension in at least one other spatial direction by a factor of at least 1.3, and in which said larger dimension extends in a spatial direction parallel to the at least one surface of the object.

The invention will be elucidated by the following examples without being restricted thereto.

### EXPERIMENT 1

### Preparation of Oxygen Scavenging Copolymers

### Preparation of Copolymer 1

A 2 L reactor equipped with distillation column and stirrer was charged with 332.0 g ε-caprolactam, 500.0 g polyoxypropylenediamine, 2.0 g; 85 m % phosphoric acid in water solution and 36.4 g adipic acid. After 3 times having flushed the reactor with nitrogen, the reactor content was heated under stirring and atmospheric pressure gradually within one hour to a temperature of 205° C. and kept at this temperature for 19 hours. Subsequently it was further heated to 210° C. for another 3 hours. The polymerised product was released from the reactor, under nitrogen pressure, and ground. It was then extracted three times with excess boiling water and dried overnight in a vacuum stove under nitrogen atmosphere at 90° C.

### Preparation of Copolymer 2

A 2 L reactor equipped with distillation column and stirrer was charged with 410 g dimethylterephthalate, 290 g 1,4-butane diol, 550 g of a hydroxy terminated propyleneoxide based oligomer, 250 mg of titanium tetrabutoxide, 150 mg of magnesium acetate tetrahydrate and 590 mg N,N′-Hexamethylenebis(3,5-di-(tert)-butyl-4-hydroxyhydrocinnamamide).

After 3 times having flushed the reactor with nitrogen, the reactor content was heated under stirring and atmospheric pressure gradually within one hour to a temperature of 150° C., kept at this temperature for half an hour, and subsequently further heated within 2 hours to a temperature of 220° C. The thus obtained transesterified product was then further polymerised at 240° C. under vacuum (down to 2 mbar) for 180 minutes at a stirring speed of 20 RPM. The polymerised product was released from the reactor, under nitrogen pressure, in the form of a strand, cooled in water and granulated in a pelletiser.

### Preparation of Copolymer 3

A 2 L reactor equipped with distillation column and stirrer was charged with 790 g dimethylterephthalate, 560 g 1,4-butane diol, 100 g of a hydroxy terminated propyleneoxide based oligomer, 250 mg of titanium tetrabutoxide and 150 mg of magnesium acetate tetrahydrate. After 3 times having flushed the reactor with nitrogen, the reactor content was heated under stirring and atmospheric pressure gradually within one hour to a temperature of 150° C., kept at this temperature for half an hour, and subsequently further heated within 2 hours to a temperature of 220° C. The thus obtained transesterified product was then further polymerised at 240° C. under vacuum (down to 2 mbar) for 150 minutes at a stirring speed of 20 RPM. The polymerised product was released from the reactor, under nitrogen pressure, in the form of a strand, cooled in water and granulated in a pelletiser.

Preparation of Copolymer 4 (Comparative) A 2 L reactor equipped with distillation column and stirrer was charged with 800 g dimethylterephthalate, 495 g 1,4-butane diol, 100 g of a hydroxy terminated poly(tetrahydrofuran-1000), 480 mg of titanium tetrabutoxide and 300 mg of magnesium acetate tetrahydrate. After 3 times having flushed the reactor with nitrogen, the reactor content was heated under stirring and atmospheric pressure gradually within one hour to a temperature of 150° C., kept at this temperature for half an hour, and subsequently further heated within 2 hours to a temperature of 220° C. The thus obtained transesterified product was then further polymerised at 240° C. under vacuum (down to 2 mbar) for 150 minutes at a stirring speed of 20 RPM. The polymerised product was released from the reactor, under nitrogen pressure, in the form of a strand, cooled in water and granulated in a pelletiser.

### EXPERIMENT 2

### Preparation of Oxygen Scavenging Blends 1-7, A, B, C and D

Two blends (1-2) based on copolymer 1 and polyamide 6 (DSM Akulon F132-E, viscosity number 210 ml/g ISO 307, Relative Viscosity measured in 90% formic acid at 30° C.: 3.20) were prepared varying the blend composition. Further, three blends (3-5) based on copolymer 2, additionally containing 0.05 wt % Irganox 1098, both containing the same polyamide 6 as blends 1-2 and two blends (6 and 7) based on copolymer 3 and copolymer 2 respectively were prepared. All these blends were prepared in a conical co-rotating fully intermeshing lab-scale twin-screw extruder. Cobalt stearate was added as the oxidation catalyst.

The mixing was carried out at a barrel temperature of 260° C., a rotation speed of 120 rpm and a residence time of approximately 3 minutes. All experiments were carried out under nitrogen atmosphere. The polyamide was dried before processing. Blends prepared were stored in sealed bags after processing.

For comparison, sample A based on a functionalised PPO oligomer (Jeffamine D-2000 of Huntsman) and polyamide 6 (DSM Akulon F132-E, viscosity number 210 ml/g ISO 307, Relative Viscosity measured in 90% formic acid at 30° C.: 3.20) have been prepared by a reactive extrusion process on the lab-scale twin-screw extruder with residence times of approximately 5 minutes.

For comparison copolymer 4 was blended with Co-stearate (sample B). Also a polyamide 6 reference not containing an oxygen scavenging compound was prepared (sample C) serving as a reference for samples 1-5.

Also a poly butylene terephtalate (DSM Arnite T04 200, Relative Viscosity measured of a 1 wt % solution in m-cresol at 25° C.: 1.85) a reference sample not containing an oxygen scavenging compound was prepared (sample D) serving as a reference for samples 6 and 7, see table 1.

TABLE 1

| | | | | DSM | PPO | |
|---|---|---|---|---|---|---|
| | Oxygen | OSC | Akulon | Arnite | blend | Co(St)₂ |
| | scavenging | amount | F132-E | T04 200 | Content | content |
| Blend | compound (OSC) | (wt %) | (wt %) | (Wt %) | (wt %) | (ppm) |
| 1 | Copolymer 1 | 3 | 96.65 | | 1.8 | 3500 |
| 2 | Copolymer 1 | 5 | 95.65 | | 3.0 | 3500 |
| 3 | Copolymer 2 | 8 | 91.65 | | 3.0 | 3500 |
| 4 | Copolymer 2 | 24 | 75.65 | | 9.0 | 3500 |
| 5 | Copolymer 2 | 48 | 51.65 | | 18.0 | 3500 |
| 6 | Copolymer 3 | 99.65 | | | 6.8 | 3500 |
| 7 | Copolymer 2 | 99.65 | | | 37.5 | 3500 |
| A | Jeffamine* | 4.8 | 95.85 | | 4.8 | 3500 |
| | D-2000 | | | | | |
| B | Copolymer 4 | 99.65 | | | | 3500 |
| | (comparative) | | | | | |
| C | None | | 100 | | | |
| D | None | | | 100 | | |

*Amine end-capped PPO of Huntsman

### EXPERIMENT 3

### Preparation of Multi Layer Oxygen Scavenging Films of Blends 1-7, A, B, C, D

Tri-layer films were produced with a PE layer at one side, an oxygen scavenger layer as mid layer and a PA6 layer at the other side. These tri-layer films were prepared by a film cast extrusion process. Three single screw extruders (two extruders with screw diameter 30 mm, UD=30 and one extruder with screw diameter 25 mm, L/D=25) were connected with a feedblock (5-layer) with a slot die with adjustable die-lip. In the feedblock some melt channels were blocked in order to achieve a tri-layer melt. The 25 mm extruder was feeded with PE based material, the two 30 mm extruders were feeded with PA6 and with the blend materials and reference materials as described below. The temperature setting of last extrusion zones, feedblock and die is 260° C. The die-width is 300 mm and the die-width is 1 mm. Film speed at the chill role is approximately 10 m/min. The tri-layer film is cooled at the PE-side on a chill role with temperature setting 20° C. Total thickness of the tri-layer film is regulated by the drawdown ratio. So for instance, with a draw-down ratio of 10, the total thickness of the film is approximately 100 μm. Total throughput of the three extruders is in the range 16-23 kg/hrs. By variation of the throughput of the individual extruders, the individual film thicknesses in the tri-layer film are varied. The resulting film thickness of the PA6 layer is for all samples 30 μm. The resulting film thickness of the PE layer is 30 μm as well for all samples. The thickness of the mid-layer varies between 30 and 75 μm as indicated for each sample further on.

### PE Layer

A Sabic LLDPE grade was applied with a density of 920 kg/m3 (ISO 1183A) and a MFI of 2.8 g/10 min (ISO 1133). To obtain adhesion with the mid-layer, 20 wt % of Yparex 8403 (maleic anhydride (MA)-modified PE grade from DSM Engineering Plastics) was added to this LLDPE grade as dry blend.

### PA-6 Layer

As commercial polyamide 6 (PA6) (DSM Akulon F132-E, viscosity number 210 ml/g ISO 307, Relative Viscosity measured in 90% formic acid at 30° C.: 3.20) was applied. The mid-layer is based on blends 1-7 and reference materials A,B,C,D. The thickness of the mid-layer for each of the produced tri-layer films is given in tables 2A, 2B and 3.

The oxygen permeability of a 30 μm thick film of the above given PE based dry blend amounts 3500 cm³/m²·24 h·atm as measured according to ASTM standard 3985 under dry conditions. The oxygen permeability of a 30 μm thick film of the above given PA6 equals 34 cm³/m²·24 h·atm as measured according to ASTM standard 3985 under dry conditions.

Additionally, tri-layer systems based on PA6 as the two outer layers and blend number 3 as mid-layer were prepared according to the above described production method for tri-layer films. PA6 applied is identical to the PA6 described above. As comparative example, a tri-layer system based on three PA6 layers is prepared as well.

### EXAMPLES I-VI AND COMPARATIVE EXPERIMENTS A-E

### Measuring of Oxygen Permeability of Films

The oxygen permeability of the prepared tri-layers was measured by a MOCON OX-TRAN 2/21 permeameter according to ASTM D3985 by exposing the tri-layer films to a nitrogen environment on one side and, an air or an oxygen atmosphere at the other side of the tri-layer films, leading to an oxygen partial pressure difference over the films of 0.2 or 1 bar respectively. The permeability tests were conducted under dry conditions and at a relative humidity of 85% at room temperature (23° C.) The measurements were started after 50 hours conditioning at the measurement conditions.

In Table 2a and 2b the oxygen permeability is presented for the various films. The measured oxygen permeability of the tri-layer film is normalised with respect to the film thickness of the mid-layer.

TABLE 2a

| | Oxygen | | |
|---|---|---|---|
| | scavenger | | |
| Examples/ | mid-layer | Thickness of the | Oxygen permeability |
| Comparative | made of | oxygen scavenger | cc · mm/ |
| Experiments | blend no. | mid-layer (μm) | (m² * day * 0.2 atm) |
| I | 1 | 30 | 0.10 |
| II | 1 | 50 | 0.01 |
| III | 2 | 30 | 0.04 |
| IV | 2 | 50 | 0.00 |
| A (comparative) | Comp. C | 30 | 0.2 |
| | (PA6 | | |
| | reference) | | |
| B (comparative) | Comp. C | 50 | 0.24 |
| | (PA6 | | |
| | reference) | | |

Oxygen permeability of the PA6, oxygen scavenger, PE multi layer film (PA6 in contact with the oxygen containing atmosphere) measured with an oxygen partial pressure difference of 0.2 bar (atmospheric conditions) and a relative humidity of 85% at 23° C.

Oxygen permeability of the PA6, oxygen scavenger, PE multi layer film (PA6 in contact with the oxygen containing atmosphere) measured with an oxygen partial pressure difference of 1 bar and under dry conditions at 23° C.

TABLE 2b

| | Oxygen | | Oxygen |
|---|---|---|---|
| Experiment/ | scavenger | Thickness of the | permeability |
| Comparative | layer made | oxygen scavenger | cc · mm/(m² * |
| Example | of blend no. | (middle) layer (μm) | day * 0.2 atm) |
| V | 3 | 55-75 | <0.1 |
| VI | 6 | 55-75 | <0.1 |
| C (comparative) | A | 55-75 | 0.25 |
| D (comparative) | B | 55-75 | 0.9 |
| E (comparative) | C | 55-75 | 0.65 |
| F(comparative) | D | 55-75 | 9.85 |

### EXAMPLES VII-IX AND COMPARATIVE EXPERIMENTS G-H

### Measuring the Oxygen Absorption of the PA6, Oxygen Scavenger, PE Multi Layer Film

The oxygen scavenger activity of the multilayer films was determined. 1 gram of a multi layer film was brought into contact with an atmosphere containing 2% of dry oxygen in a volume of 125 ml. In this vessel, a fluorescence dye was incorporated (O2xyDot™) After 72 hours the concentration of oxygen was monitored using a O2xySense™ 210T. The oxygen absorption results are shown in Table 3.

TABLE 3
Relative oxygen absorption of the PA6, oxygen scavenger,
PE multi layer film.

| | Oxygen | | |
|---|---|---|---|
| Experiment/ | scavenger | Thickness of the | Drop in oxygen |
| Comparative | layer made | oxygen scavenger | concentration after |
| Example | of blend no. | (middle) layer (μm) | 72 hrs |
| VII | 4 | 55-75 | >70% |
| VIII | 5 | 55-75 | >70% |
| IX | 7 | 55-75 | >70% |
| G | C (PA6 | 55-75 | <10% |
| | reference) | | |
| H | D (PBT | 55-75 | <10% |
| | reference) | | |

### EXAMPLE X AND COMPARATIVE EXPERIMENT I

### Measuring of Oxygen Permeability of Films

The oxygen permeability of the prepared tri-layers was measured by a MOCON OX-TRAN 2/21 permeameter according to ASTM D3985 by exposing the tri-layer films to a nitrogen environment on one side and, an air or an oxygen atmosphere at the other side of the tri-layer films, leading to an oxygen partial pressure difference over the films of 1 bar. The permeability tests were conducted under dry conditions at room temperature (23° C.) The measurements were started after 50 hours conditioning at the measurement conditions.

In Table 4 the oxygen permeability is presented for the films. The measured oxygen permeability of the tri-layer film is normalised with respect to the film thickness of the mid-layer.

Oxygen permeability of the PA6, oxygen scavenger, PA6 multi layer film measured with an oxygen partial pressure difference of 1.0 bar under dry conditions at 23° C.

TABLE 4

| | Oxygen | | |
|---|---|---|---|
| | scavenger | | |
| Experiment/ | mid-layer | Thickness of the | |
| Comparative | made of | oxygen scavenger | Oxygen permeability |
| Example | blend no. | mid-layer (μm) | cc · mm/(m² * day * atm) |
| X | 3 | 55-75 | <0.05 |
| I | C (PA6 | 55-75 | 0.5 |
| | reference) | | |

1. Oxygen scavenging multilayer film, comprising a layer that comprises an oxygen scavenging composition, said layer being separated from a first surface of the film by one or more first layers, characterized in that the oxygen scavenging composition comprises a copolymer comprising substituted polypropylene oxide segments and polymer segments and an oxidation catalyst, wherein the copolymer has been prepared by copolymerising the corresponding monomers of the polymer segments in the presence of functionalised substituted polypropylene oxide segments, wherein the first layers have an overall oxygen permeability of at most 500 cm³/m²·24 h·atm.

2. Oxygen scavenging film according to claim 1, wherein the layer that comprises the oxygen scavenging composition farther comprises polyamide or polyester.

3. Oxygen scavenging film according to claim 1, wherein the polymer segments are polyamide or polyester segments.

4. Oxygen scavenging film according to claim 1, wherein the oxygen scavenging composition is present in at least a layer forming a second surface of the film, opposite to the first surface, or being separated from said second surface by one or more second layers, the second layers having an overall oxygen permeability of more than 500 cm³/m²·24 h·atm.

5. Oxygen scavenging film according to claim 4, wherein the relative amount of PPO segments in the layer that comprises the oxygen scavenging composition is in the range of 0.5-85 wt %.

6. Oxygen scavenging film according to claim 5, wherein the polypropylene oxide segments form a co-continuous phase in the oxygen scavenging composition.

7. Oxygen scavenging film according to claim 1, wherein the layer comprising the oxygen scavenging composition is separated from a second surface of the film, opposite to the first surface, by one or more second layers, the second layers having an overall oxygen permeability of at most 500 cm³/m²·24 h·atm.

8. Oxygen scavenging film according to claim 7, wherein the relative amount of PPO segments in the layer that comprises the oxygen scavenging composition is in the range of 0.5-40 wt %.

9. Oxygen scavenging film according to claim 7, wherein the PPO segments are present as conglomerates and at most 25% of the conglomerates have a size above 500 nm.

10. Oxygen scavenging film according to claim 7, wherein conglomerates of the polypropylene oxide segments are present, of which conglomerates at least 90% has a dimension in at least one spatial direction that is larger than a dimension in at least one other spatial direction by a factor of at least 1.3, and in which said larger dimension extends in a direction essentially parallel to the surfaces of the film.

11. Oxygen scavenging package comprising a film according to claim 1.

12. Method for extending the shelf life of oxygen sensitive material, comprising the step of packaging the material in a package according to claim 11.
